(19) United States
(12) Patent Application Publication
(10) Pub. No.: US 2016/0261601 A1
(43) Pub. Date: Sep. 8, 2016

(54) WIRELESS ROUTER, FAST ACCESS CONTROL METHOD AND AUTHENTICATION CONNECTION METHOD OF WIRELESS ROUTERS

(71) Applicant: KZ BROADBAND TECHNOLOGIES, LTD, Shenzhen (CN)

(72) Inventors: Zongyi Zhou, Shenzhen (CN); Xiaoru Liao, Shenzhen (CN); Jinpeng Cheng, Shenzhen (CN)

(21) Appl. No.: 15/157,478

(22) Filed: May 18, 2016

Related U.S. Application Data
(63) Continuation of application No. PCT/CN2014/082931, filed on Jul. 24, 2014.

(30) Foreign Application Priority Data
Nov. 18, 2013 (CN) 201310578882.5

(51) Int. Cl. H04L 29/06; H04W 12/06; H04W 4/02; H04W 52/38; H04W 76/02

(52) U.S. Cl. CPC H04L 63/101; H04W 52/38; H04W 76/02; H04W 4/023; H04L 63/0876; H04W 12/06; H04W 84/12

(57) ABSTRACT

The present provides a fast access control method of a wireless router based on a message authentication code (MAC) white list, which includes following steps: the wireless router entering into a creation mode controlled based on the MAC white list; the wireless router reducing its wireless signal transmission power; if there is a wireless terminal which attempts to connect to the wireless router in an effective period of time of the creation mode controlled by the MAC white list, storing MAC information of the wireless terminal in the MAC white list; when the effective period of time of the creation mode controlled by the MAC white list expires, completing creation of the MAC white list, and the wireless router restoring its wireless signal transmission power to a normal state. The method enables wireless terminals to quickly, conveniently and securely access wireless signals of the wireless router.

### CROSS-REFERENCE TO RELATED APPLICATIONS

The present application is a Continuation Application of PCT application No. PCT/CN2014/082931 filed on Jul. 24, 2014, which claims the benefit of Chinese Patent Application No. 201310578882.5 filed on Nov. 18, 2013, the contents of which are hereby incorporated by reference.

### TECHNICAL FIELD

The present disclosure relates to the field of wireless communication technology, in particular to a wireless router, a fast access control method and an authentication connection method of the wireless router.

### BACKGROUND

Wireless fidelity (WIFI) is an important wireless local area network technology, and is also used for wireless broadband access at the same time. WIFI has such advantages as fast net speed, low cost, higher bandwidth, and using spectral non-required authorization. There are generally two modes for user terminals (for example, notebook computer, platform computer, mobile phone, intelligent television, and the like) to access to a wireless local area network through a wireless terminal: the wireless terminal is connected with the wireless local area network by inputting passwords or by way of WPS automatic negotiation.

Wi-Fi Protected Setup (WPS) is introduced on Jan. 8, 2007 by WiFi. An object of WPS is to simplify the configuration procedure of the wireless network, so that users do not need to understand wireless security knowledge and can correctly connect the wireless terminal to the WIFI wireless network. In WPS, there are four modes for wireless terminals access to wireless routers: personal information number (PIN) mode: PIN information of a wireless terminal must be input into a wireless router in advance so that the wireless terminal can correctly access; push button configuration (PBC) mode: pressing one key of a wireless terminal and one key of a wireless router at the same time to synchronize WIFI encrypted information; near field communication contactless token configuration (NFC) mode: moving a wireless terminal close to a wireless router to exchange WIFI encrypted information through a short-range wireless communication technology such as RFID; USB flash drive configuration (UFD) mode: using a USB to exchange WIFI encrypted information between a wireless terminal and a wireless router.

Each of the above four modes for wireless terminals to access to wireless routers has certain limitations. The PIN mode requires users to input information of access terminals in advance to a wireless router. The PBC mode requires for adding a button on each of a wireless router and a wireless terminal. The NFC mode requires for adding a wireless module in each of a wireless router and a wireless terminal. The UFD mode requires each of a wireless router and a wireless terminal having a USB interface, but most of the existing network equipment do not have USB interfaces.

For the mode of using passwords to connect wireless terminals, the passwords may be forget after a long time, and other equipment which is never connected to the wireless terminal cannot access. Resetting the passwords also requires a more complicated operation; after this resetting, it cannot be ensured that the passwords can be timely found when needing to use the passwords later.

In view of the above problems or inconvenience existing in the authentication connection method for access the wireless local area network, therefore, a simple configuration method and device widely applied to the wireless local area network for wireless terminals access to the wireless router have important application value.

### SUMMARY

A technical problem to be solved by the present disclosure is to provide a wireless router, a fast access control method and an authentication connection method of the wireless router, which can solve the problem that the existing authentication connection method of the wireless terminal is inconvenient.

The present disclosure is implemented in following ways. A fast access control method of a wireless router based on a message authentication code (MAC) white list, includes following steps:
the wireless router entering into a creation mode controlled based on the MAC white list;
the wireless router reducing its wireless signal transmission power; if there is a wireless terminal which attempts to connect to the wireless router in an effective period of time of the creation mode controlled by the MAC white list, storing MAC information of the wireless terminal in the MAC white list;
when the effective period of time of the creation mode controlled by the MAC white list expires, completing creation of the MAC white list, and the wireless router restoring its wireless signal transmission power to a normal state.

Further, the wireless router entering into the creation mode controlled by the MAC white list is implemented by pressing a switching button of the wireless router.

Further, a decrease of the wireless signal transmission power is adjustable.

Further, the effective period of time of the creation mode controlled by the MAC white list is adjustable.

The present disclosure further provides a wireless router, including:
a working mode switching unit configured to switch the wireless router from a normal mode to a creation mode controlled by a MAC white list;
an MAC white list creation unit configured to, after the working mode switching unit is switched to the creation mode controlled by the MAC white list, store in the MAC white list, MAC information of a wireless terminal which attempts to connect to the wireless router in an effective period of time;
a wireless signal transmission unit configured to, after the working mode switching unit is switched to the creation mode controlled by the MAC white list, and the MAC white list creation unit reduces a wireless signal transmission power before creating the MAC white list, and when the working mode switching unit is switched to the normal mode, restore wireless signal to a normal state.

Further, the working mode switching unit is a switching button.

Further, the MAC white list creation unit includes a built-in time controller; the time controller is configured to control a length of the effective period of time; a length of the effective period of time is adjustable.

Further, a decrease of the wireless signal transmission power transmitted from the wireless signal transmission unit is adjustable.

The present disclosure further provides an authentication connection method of a wireless router, including following steps:
receiving a connection request of a wireless terminal;
judging whether there is MAC information of the wireless terminal which requests for connection in an MAC white list;
if a judgment result is there is, allowing the wireless terminal to access the wireless router; otherwise, not allowing the wireless terminal to access the wireless router.

The present disclosure further provides a wireless router, including:
a connection request receiving unit configured to receive a connection request of a wireless terminal;
a judgment unit configured to judge whether there is MAC information of the wireless terminal which requests for connection in an MAC white list;
a connection request processing unit configured to, when a judgment result of the judgment unit is there is, allow the wireless terminal to access the wireless router, otherwise, not allow the wireless terminal to access the wireless router.

Comparing with the related art, the beneficial advantages include: in the fast access control method of the wireless router based on the MAC white list, the MAC white list is created to record the MAC information of the wireless terminals, the created MAC white list can permanently store the MAC information of the wireless terminals which access within the effective period of time; thus, the method does not require users of the wireless terminals to input passwords and does not require the terminals to support special function configurations such as WPS, and can be compatible with more kinds of wireless products and enable wireless terminals to quickly and conveniently access the wireless router. In the process of access, the range of access is reduced by controlling the effective period of time for accessing and reducing the wireless signal transmission power, thereby improving safety of access.

### BRIEF DESCRIPTION OF THE DRAWINGS

FIG. 1 is a flow chart of a fast access control method of a wireless router based on a message authentication code (MAC) white list according to one embodiment of the present disclosure;

FIG. 2 is a schematic diagram showing connection relationship of various modules of the wireless router according to one embodiment of the present disclosure; and

FIG. 3 is an overall flow chart of an authentication connection method of wireless signals and the fast access control method of the wireless router based on the MAC white list according to one embodiment of the present disclosure.

### DETAILED DESCRIPTION

In order to make the objects, the technical solutions and the advantages of the present disclosure more apparent, the present disclosure will be described hereinafter in conjunction with the drawings and the embodiments. It should be appreciated that, following embodiments are for illustrating the present disclosure, but not intended to limit the scope of the present disclosure.

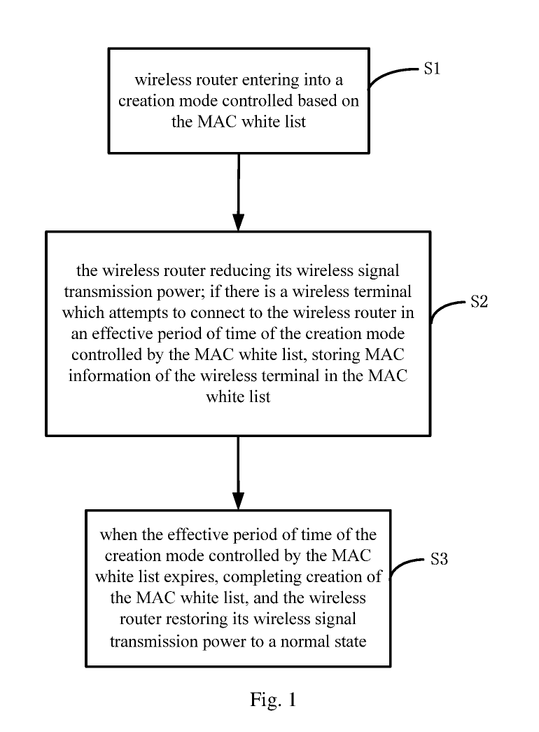

As shown in FIG. 1, according to one preferred embodiment of the present disclosure, a fast access control method of a wireless router based on a message authentication code (MAC) white list includes following steps: the wireless router entering into a creation mode controlled based on the MAC white list; the wireless router reducing its wireless signal transmission power; if there is a wireless terminal which attempts to connect to the wireless router in an effective period of time of the creation mode controlled by the MAC white list, storing MAC information of the wireless terminal in the MAC white list; when the effective period of time of the creation mode controlled by the MAC white list expires, completing creation of the MAC white list, and the wireless router restoring its wireless signal transmission power to a normal state. In the above steps, the MAC white list records user names and related information of the wireless terminals which are allowed to access the wireless router. An MAC black list corresponding to the MAC white list, and the MAC black list is configured to record user names and related information of wireless terminals which are not allowed to access the wireless router.

The wireless router entering into the creation mode controlled by the MAC white list can be implemented by pressing a switching button of the wireless router. Only when the switching button is pressed, the wireless router can enter into the creation mode controlled by the MAC white list. When the effective period of time of the creation mode controlled by the MAC white list expires, the wireless router can automatically restore its wireless signal transmission power to the normal state without pressing the switching button again.

In the above steps, the wireless router reducing its wireless signal transmission power is to reduce a coverage range of wireless signals so as to ensure safety of access. A decrease of the wireless signal transmission power is usually about 10% of the normal power. According to size of range allowing access to wireless signals, the decrease of the wireless signal transmission power can be appropriately adjusted, for example, by 6%, 15%, or 20%, etc.

Combined with the above various embodiments, the effective period of time of the creation mode allowed to be controlled by the MAC white list (i.e., allowing access to wireless signals) is adjustable. The effective period of time is to allow users of wireless terminals who needs to access the wireless router to connect the wireless router within a predetermined short period of time, so as to shorten a period of time when allowing access to the wireless router and prevent excessive users who are not allowed to access the wireless signals from access. The effective period of time of the creation mode controlled by the MAC white list can be set to be 30 seconds, and the short period of time when allowing access to the wireless router can also be set to be other values according to needs.

On the basis of the above fast access control method of the wireless router based on the MAC white list, the present disclosure further provides a wireless router. As shown in FIG. 3, the wireless router includes a working mode switching unit 301 configured to switch the wireless router from a normal mode to a creation mode controlled by a MAC white list; an MAC white list creation unit 302 configured to, after the working mode switching unit 301 is switched to the creation mode controlled by the MAC white list, store in the MAC white list, MAC information of the wireless terminal which attempts to connect to the wireless router in an effective period of time; a wireless signal transmission unit 303 configured to, after the working mode switching unit 301 is switched to the creation mode controlled by the MAC white list, and the MAC white list creation unit 302 reduces a wireless signal transmission power before creating the MAC white list, and when the working mode switching unit 301 is switched to the normal mode, restore the wireless signal transmission power to a normal state.

The working mode switching unit 301 is a switching button. When pressing the switching button, in case that one wireless terminal finds wireless signal of the wireless router, direct click can access to the wireless signal. The wireless router stores MAC information of the wireless terminal which accesses to the wireless router. In the next use, the wireless terminal can directly use wireless signals without performing the access operation.

The MAC white list creation unit 302 includes a built-in time controller. The time controller is configured to control a length of the effective period of time. The length of the effective period of time is adjustable. The decrease of the wireless signal transmission power transmitted from the wireless signal transmission unit 303 is adjustable. The adjustment of the effective period of time and the decrease of the wireless signal transmission power are to control the number of users who are allowed to access to the wireless router, thereby improving safety of access.

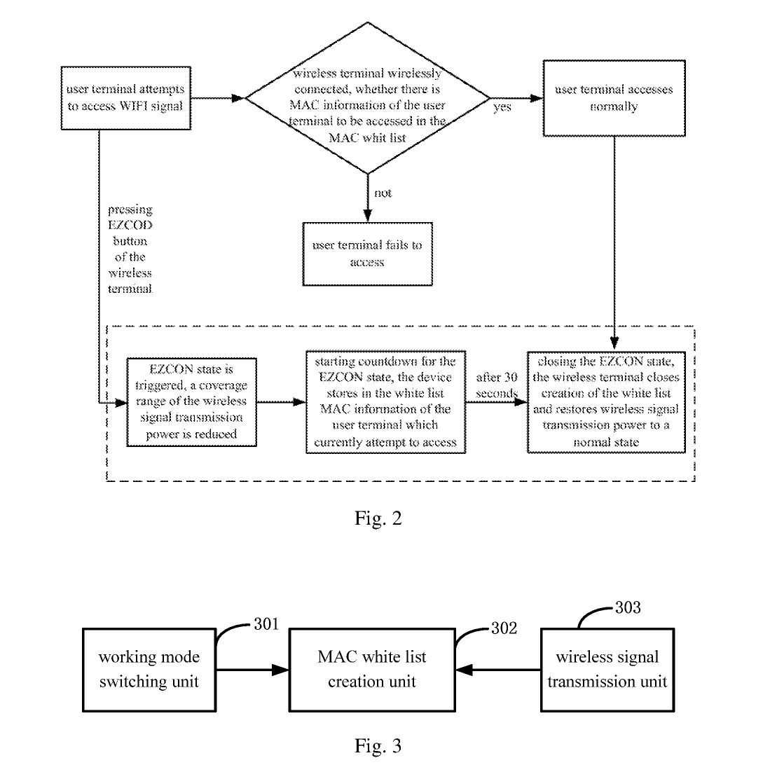

As shown in FIG. 2, an authentication connection method of wireless routers includes following steps: receiving a connection request of a wireless terminal; judging whether there is MAC information of the wireless terminal which requests for connection in an MAC white list; if a judgment result is there is, allowing the wireless terminal to access the wireless router; otherwise, not allowing the wireless terminal to access the wireless router.

When missing the open period of time when allowing access to the wireless signals, one wireless terminal cannot access to the wireless signals. If the one wireless terminal needs to access, it is required to press the working mode switching button 304 again to reactivate the MAC white list creation unit 302.

When there is MAC information of one wireless terminal which is not allowed to access to the wireless router in the MAC white list, wireless terminal information of this user is directly put into the MAC black list. The users in the MAC black list cannot use wireless signals of the wireless router.

Based on the above authentication connection method of wireless routers, the present disclosure further provides a wireless router. The wireless router includes a connection request receiving unit configured to receive a connection request of a wireless terminal; a judgment unit configured to judge whether there is MAC information of the wireless terminal which requests for connection in an MAC white list; a connection request processing unit configured to, when a judgment result of the judgment unit is there is, allow the wireless terminal to access the wireless router, otherwise, not allow the wireless terminal to access the wireless router.

The above are merely preferred embodiments of the present disclosure, but not intended to limit the scope of the present disclosure. Any modifications, equivalent replacements and improvements made without departing from the spirit and principle of the present disclosure shall also fall within the scope of the present disclosure.

What is claimed is:

1. A fast access control method of a wireless router based on a message authentication code (MAC) white list, comprising following steps:
the wireless router entering into a creation mode controlled based on the MAC white list;
the wireless router reducing its wireless signal transmission power; if there is a wireless terminal which attempts to connect to the wireless router in an effective period of time of the creation mode controlled by the MAC white list, storing MAC information of the wireless terminal in the MAC white list;
when the effective period of time of the creation mode controlled by the MAC white list expires, completing creation of the MAC white list, and the wireless router restoring its wireless signal transmission power to a normal state.

2. The fast access control method according to claim 1, wherein the wireless router entering into the creation mode controlled by the MAC white list is implemented by pressing a switching button of the wireless router.

3. The fast access control method according to claim 1, wherein a decrease of the wireless signal transmission power is adjustable.

4. The fast access control method according to claim 1, wherein the effective period of time of the creation mode controlled by the MAC white list is adjustable.

5. A wireless router comprising:
a working mode switching unit configured to switch the wireless router from a normal mode to a creation mode controlled by a MAC white list;
an MAC white list creation unit configured to, after the working mode switching unit is switched to the creation mode controlled by the MAC white list, store in the MAC white list, MAC information of a wireless terminal which attempts to connect to the wireless router in an effective period of time;
a wireless signal transmission unit configured to, after the working mode switching unit is switched to the creation mode controlled by the MAC white list, and the MAC white list creation unit reduces a wireless signal transmission power before creating the MAC white list, and when the working mode switching unit is switched to the normal mode, restore wireless signal to a normal state.

6. The wireless router according to claim 5, wherein the working mode switching unit is a switching button.

7. The wireless router according to claim 5, wherein the MAC white list creation unit comprises a built-in time controller; the time controller is configured to control a length of the effective period of time; a length of the effective period of time is adjustable.

8. The wireless router according to claim 5, wherein a decrease of the wireless signal transmission power transmitted from the wireless signal transmission unit is adjustable.

9. An authentication connection method of a wireless router, comprising the following steps:
receiving a connection request of a wireless terminal;
judging whether there is MAC information of the wireless terminal which requests for connection in an MAC white list;
if a judgment result is there is, allowing the wireless terminal to access the wireless router; otherwise, not allowing the wireless terminal to access the wireless router.
